(19) United States
(12) Patent Application Publication
(10) Pub. No.: US 2011/0195255 A1
(43) Pub. Date: Aug. 11, 2011

(54) POLYTHIOPHENE-BASED CONDUCTIVE POLYMER MEMBRANE

(75) Inventors: Jin Hwan Kim, Suwon-si (KR); In Sook Ahn, Anyang-si (KR); Hee Dong Son, Seoul (KR); Dae Gi Ryu, Yongin-si (KR)

(73) Assignee: SKC Co. Ltd, Suwon-si Gyeonggi-do (KR)

(21) Appl. No.: 12/739,586

(22) PCT Filed: Jan. 30, 2008
(86) PCT No.: PCT/KR2008/000560

§ 371 Date: Apr. 23, 2010

(30) Foreign Application Priority Data
Oct. 23, 2007 (KR) 1020070106844

(51) Int. Cl. H01B 1/12; B32B 27/28; B32B 27/06; B32B 27/08

(52) U.S. Cl. 428/412; 252/500; 252/514; 252/512; 252/519.33; 428/419; 977/779

(57) ABSTRACT

The present invention relates to a polythiophene-based conductive polymer membrane, which has a conductivity of 1 KΩ/m² or less, a light transmission of 95% or more, and a contact resistance ranging from 0.5 to 2 KΩ. Accordingly, the inventive polymer membrane exhibiting such good performance characteristics can be advantageously used as an electrode film for various applications.

### FIELD OF THE INVENTION

The present invention relates to a polythiophene-based conductive polymer membrane exhibiting highly improved performance characteristics such as high conductivity, transparency, water tolerance and durability, and low contact resistance.

### BACKGROUND OF THE INVENTION

Polyethylenedioxythiophene (PEDT) is a highly transparent conductive polymer widely used in the coating of Braun tube glass for shielding electromagnetic waves, and a water-dispersible PEDT is commercially available under the trade mark “Baytron P” (from Bayer Corporation), which is prepared by doping PEDT with a polymeric acid salt such as a polystyrene sulfonate salt for improved conductivity.

Although the doped PEDT shows excellent transparency, it is difficult to achieve a high conductivity of less than 1 KΩ/m² and its electrical property can be easily compromised when it is exposed to a high humidity over a long period of time.

Further, Korean Patent Publication No. 2000-10221 has disclosed a conductive polymer composition comprising polyethylenedioxythiophene, an alcohol, an amide and a polyester-based resin binder; Korean Patent Publication No. 2005-66209, a conductive polymer composition comprising polyethylenedioxythiophene, an alcohol, an amide and a silane coupling agent; and Korean Patent Publication No. 2005-97582, a conductive polymer composition comprising polyethylenedioxythiophene, an alcohol, an amide, nanoparticles of an organic or inorganic compound and a sulfoxide derivative.

However, the electrical properties of such conductive polymer compositions can easily change when exposed to a high temperature and humidity condition. Also, the composition disclosed in Korean Patent Publication No. 2005-97582 exhibits a relatively high contact resistance of more than 5 KΩ due to the use of an excessive amount of the organic or inorganic particles.

### SUMMARY OF THE INVENTION

Accordingly, it is an object of the present invention to provide a conductive polymer membrane which exhibits improved performance characteristics in terms of conductivity, transparency, water tolerance, durability and contact resistance.

In accordance with one aspect of the present invention, there is provided a polythiophene-based conductive polymer membrane having a conductivity of 1 KΩ/m² or less, a light transmission of 95% or more, and a contact resistance ranging from 0.5 to 2 KΩ.

### DETAILED DESCRIPTION OF THE INVENTION

The polythiophene-based conductive polymer membrane of the present invention has a feature of possessing a conductivity of 1 KΩ/m² or less, a light transmission of 95% or more, and a contact resistance ranging from 0.5 to 2 KΩ, which can be achieved by combining a polythiophene-based conductive polymer, an inorganic material or compound, melamine resin, and a binder.

The inventive polymer membrane may be formed from a liquid composition, which comprises (1) an aqueous solution of a polythiophene-based conductive polymer, (2) an alcohol-based organic solvent, (3) an amide-based organic solvent or a nonprotonic polar solvent, (4) a dispersion of an inorganic material or compound, (5) melamine resin, and (6) a binder selected from the group consisting of polyester, polyurethane, alkoxysilane and a mixture thereof.

In the liquid composition of the present invention, the amide-based organic solvent or the nonprotonic polar solvent (component 3) plays an important role of enhancing the connectivity and dispersibility of the polythiophene-based conductive polymer molecules due to its ability to partially dissolve said polymer molecules; the melamine resin (component 5) having NH⁺ moieties interacts with the SO₃⁻ moieties of the polythiophene-based conductive polymer to exclude the excessive hydration of the moieties, which leads to enhance the water resistance and time-dependent electrical stability of the inventive polymer membrane; the inorganic material or compound (component 4) contributes to the lowering of the contact resistance of the inventive polymer membrane when subjected to pressure contact in such application cases as a touch panel and a mobile phone; and the binder (component 6) enhances the durability and the adhesive strength of the inventive polymer membrane to a substrate.

Hereinafter, the components of the liquid composition of the present invention are described in detail as follows:

### 1. Aqueous Solution of Polythiophene-Based Conductive Polymer

The polythiophene-based conductive polymer used in the aqueous solution of the polythiophene-based conductive polymer may be any one of the known polythiophene-based conductive polymers conventionally used in the art. Preferred examples of the polythiophene-based conductive polymer include polyethylenedioxythiophene (PEDT) doped with a polystyrene sulfonate salt (PSS) as a stabilizing agent (dopant) (trade mark “Baytron P” from Bayer Corporation), which shows a high solubility in water and excellent thermal and storage stabilities. Since PEDT can be easily mixed with water, an alcohol or a solvent having large dielectric constant, PEDT can be conveniently coated on a substrate using an appropriate solution thereof. Also, the coated membrane formed from PEDT exhibits excellent transparency as compared with a membrane formed from any one of other conductive polymers, e.g., polyaniline and polypyrrole.

The aqueous solution of the polythiophene-based conductive polymer may have a solid content ranging from 1 to 5 wt % which helps its water-dispersibility.

In the present invention, the aqueous solution of the polythiophene-based conductive polymer may be employed in an amount ranging from 20 to 70% by weight, preferably from 26 to 67% by weight based on the total weight of the liquid composition. When the amount is less than 20% by weight, the desired conductivity of less than 1 KΩ/m² cannot be achieved, and when more than 70% by weight, the light transmission, especially the visible light transmission at a wavelength of 550 nm or higher becomes unsatisfactory (less than 95%).

### 2. Alcohol-Based Organic Solvent

The alcohol-based organic solvent used in the present invention may be a C₁₋₄ alcohol including methanol, ethanol, propanol, isopropanol and butanol, which can be used separately or as a mixture, and methanol is preferred because it enhances the dispersibility of the inventive conductive polymer.

The alcohol-based organic solvent may be used in an amount ranging from 10 to 75% by weight based on the total weight of the liquid composition. Preferably, the alcohol-based organic solvent may be employed in an amount ranging from 24 to 70% by weight when used together with an amide-based organic solvent, and from 20 to 62% by weight when used together with a nonprotonic polar solvent. When the amount is less than 10% by weight, the light transmission becomes unsatisfactory, and when more than 75% by weight, the conductivity may be reduced and the liquid composition may coagulate.

### 3. Amide-Based Organic Solvent or Nonprotonic Polar Solvent

The amide-based organic solvent used in the present invention may be at least one solvent selected from the group consisting of formamide, N-methylformamide, N,N-dimethylformamide, acetamide, N-methylacetamide, N-dimethylacetamide and N-methylpyrrolidone (NMP). These amide-based organic solvents have a common feature of having an amide group [R(CO)NR₂] (wherein, R is H, methyl, ethyl or propyl). Although a single amide-based solvent can improve the conductivity of the PEDT conductive polymer, it is preferably used in the form of a mixture of two or more of the above-mentioned amide-based solvents in order to achieve the desired transparency and contact resistance.

Further, the nonprotonic polar solvent may be dimethyl sulfoxide (DMSO), propylene carbonate or a mixture thereof.

When the nonprotonic polar solvent is used alone, it is difficult to expect the enhanced conductivity of the inventive conductive polymer. Therefore, it is preferred to employ the nonprotonic polar solvent as a mixture with at least one dispersion stabilizer selected from the group consisting of ethyleneglycol, glycerine and sorbitol, so as to effectively improve the conductivity. The dispersion stabilizer may be used in an amount ranging from 1 to 10% by weight, preferably from 4 to 10% by weight based on the total weight of the inventive liquid composition.

Further, it is preferred to use the nonprotonic polar solvent alone without mixing with the amide-based organic solvent because the desired transparency and storage stability cannot be achieved if the two solvents are used as a mixture.

The amide-based organic solvent may be employed in an amount ranging from 1 to 10% by weight, preferably 3 to 7% by weight based on the total weight of the liquid composition; while the nonprotonic polar solvent, 1 to 10% by weight, preferably 4 to 8% by weight based on the total weight of the liquid composition. When the amount is less than the specified amount, the desired conductivity cannot be achieved, while when the amount is more than the specified amount, difficulties arise during the high temperature plasticity process.

### 4. Dispersion of Inorganic Material or Compound

The inorganic material or compound used in the present invention may be employed in the form of a powder or a dispersion, and it is preferred to use a dispersion prepared by dispersing the inorganic material or compound in water or alcohol so that the polymer membrane formed from the inventive liquid composition can attain a good appearance as well as a satisfactory property.

The inorganic material or compound may have a particle size of 100 nm or less, preferably 1 to 100 nm, which is favorable for the light transmission and in terms of the exterior appearance of the inventive polymer membrane.

In the present invention, the inorganic material or compound may be any one of the known inorganic materials or compounds conventionally used in the art, and representative examples thereof include dispersions of antimony tin oxide (ATO, solid content: 30%, AAS Series), indium tin oxide (ITO, solid content: 30%, AIS Series), gold (Au, solid content: 0.1%, AUS Series), and silver (Ag, solid content: 1.0%, AGS Series), which are commercially available from MIJITECH Co., Ltd.; and dispersions prepared using Cu, Ti and Al.

The dispersion of inorganic material or compound may be employed in an amount ranging from 0.05 to 5% by weight (solid content: 0.0005 to 1% by weight), preferably from 0.2 to 0.7% by weight based on the total weight of the liquid composition. When the amount is less than 0.05% by weight, the contact resistance may increase to a value over 5 KΩ while when the amount is more than 5% by weight, increased surface and contact resistances and decreased light transmission may occur.

### 5. Melamine Resin

The melamine resin used in the present invention has NH⁺ moieties capable of binding to SO₃⁻ groups of the polythiophene-based conductive polymer in the solution, and therefore the melamine resin improves the electrical stability of the inventive conductive polymer, which contributes to the enhancement of the water tolerance of the inventive membrane.

The melamine resin may be employed in an amount ranging from 1 to 10% by weight, preferably from 1 to 8% by weight based on the total weight of the liquid composition. When the amount is less than 1% by weight, the water tolerance of the conductive membrane becomes poor, and when more than 10% by weight, the conductivity becomes poor.

### 6. Binder

The binder is used for enhancing the durability and the substrate-adhesive strength of the inventive polymer membrane, and may be at least one selected from the group consisting of polyester, polyurethane and alkoxysilane, preferably a mixture of two or more selected from the above-mentioned binders, wherein polyester resin is preferred for it enhances the substrate-adhesive strength when the inventive liquid composition is coated on a polyethylene terephthalate film.

The polyester and polyurethane may each be any one of the known polyesters or polyurethanes conventionally used in the art, and the alkoxysilane may be a silane compound having three or four functional groups, preferably trimethoxysilane or tetraethoxysilane.

The binder may be employed in an amount ranging from 0.1 to 5% by weight, preferably from 0.5 to 4% by weight based on the total weight of the liquid composition. When the amount is less than 0.1% by weight, the substrate-adhesive strength and durability of the conductive membrane become poor, and when more than 5% by weight, a high conductivity cannot be achieved.

The liquid composition of the present invention may further comprise a slipping agent and a viscosity depressant in order to prevent the blocking of the coated surface and also to increase the slip property, and the slipping agent and viscosity depressant may each be employed in an amount ranging from 0.05 to 5 parts by weight based on the total weight of the liquid composition.

The liquid composition of the present invention may be prepared by a conventional method comprising mixing and stirring the above mentioned components, and the conductive polymer membrane of the present invention may be formed by coating the liquid composition on a substrate, and drying the coated substrate.

The polythiophene conductive polymer membranes for shielding electromagnetic waves and for electrodes may be prepared by coating the inventive liquid composition on a transparent substrate such as a Braun tube (TV, computer) glass plate, casting polypropylene (CPP) film, polyethylene terephthalate film, polycarbonate film and acryl panel, and drying the coated substrate at a temperature ranging from 100 to 145 for 1 to 10 mins. The coating process may be conducted using any of the conventional methods such as bar coating, roll coating, flow coating, dip coating and spin coating. The dried conductive polymer membrane preferably has a thickness of 5 μm or less.

The inventive polymer membrane thus obtained exhibits a conductivity of 1 KΩ/m² or less, preferably 0.1 to 1 KΩ/m²; a light transmission of 95% or more, preferably 95 to 99%; and a contact resistance ranging from 0.5 to 2 KΩ. Accordingly, the inventive polymer membrane can be advantageously used as top and bottom electrode films for a touch panel, an inorganic light emitting diode (EL) for a mobile phone and a transparent electrode film for a display, which require the capabilities to prevent static charge accumulation and to shield electromagnetic waves, as well as high conductivity, transparency, water tolerance, durability, and low contact resistance.

The following Examples are intended to further illustrate the present invention without limiting its scope.

### Examples 1 to 9 and Comparative Examples 1 to 15

### Preparation of Liquid Composition

While vigorously stirring an aqueous solution of polyethylenedioxythiophene (PEDT) conductive polymer, other ingredients specified in Tables 1 to 3 were successively added thereto at about 7 min-intervals, and the resulting mixture was homogenized to obtain a liquid composition. The liquid compositions of Examples 1 to 9 and Comparative Examples 1 to 15 obtained by repeating the above procedure are shown in Tables 1 to 3.

TABLE 1

| | Aqueous | | Amide- | | Binder |
|---|---|---|---|---|---|
| | PEDT | | based | Melamine | (polyester-based/urethane- |
| Ingredient (g) | solution | Alcohol | solvent | resin | based/alkoxysilane-based) |
| Comparative | 46.2 | MeOH | FA (2) | melamine | PET(aq) |
| Example 1 | | (48.8) | NMP (1) | resin (1) | (1) |
| Comparative | 46.2 | MeOH | FA (2) | melamine | A-187 |
| Example 2 | | (46.8) | NMP (1) | resin (3) | (1) |
| Comparative | 46.2 | MeOH | FA (2) | melamine | — |
| Example 3 | | (45.8) | NMP (1) | resin (5) | |
| Comparative | 46.2 | MeOH | FA (2) | — | A-187 |
| Example 4 | | (49.8) | NMP (1) | | (1) |
| Comparative | 46.2 | MeOH | FA (2) | — | PET(aq) |
| Example 5 | | (48.8) | NMP (1) | | (2) |
| Comparative | 46.2 | MeOH | FA (2) | — | — |
| Example 6 | | (50.8) | NMP (1) | | |
| Comparative | 46.2 | MeOH | FA (2) | — | TEOS |
| Example 7 | | (46.8) | NMP (1) | | (4) |
| Comparative | 46.2 | MeOH | FA (2) | — | — |
| Example 8 | | (50.8) | NMP (1) | | |
| Comparative | 46.2 | MeOH | FA (2) | — | TEOS |
| Example 9 | | (46.8) | NMP (1) | | (4) |

PEDT: polyethylenedioxythiophene (Bayer), solid content: 1.0~1.5%
MeOH: methanol (Aldrich)
FA: formamide (Aldrich)
PET(aq): aqueous polyethylene terephthalate solution (SKC), solid content: 20%
NMP: N-methylpyrrolidone (Aldrich)
A-187: γ-glycidyloxypropyltrimethoxy silane (Degussa)
melamine resin: Aldrich, solid content: 90%
TEOS: tetraethoxysilane (Aldrich)

TABLE 2

| | | | | | Binder | |
|---|---|---|---|---|---|---|
| | | | | | (polyester- | Dispersion of |
| | Aqueous | | Amide- | | based/urethane- | inorganic |
| Ingredient | PEDT | | based | Melamine | based/alkoxysilane- | material or |
| (g) | solution | Alcohol | solvent | resin | based) | compound |
| Example 1 | 26 | MeOH | FA (2) | melamine | PET(aq) | ITO (sol) |
| | | (68.05) | NMP (1) | (2) | (0.9) | (0.05) |
| Example 2 | 26 | EtOH | FA (2) | melamine | R-986 | ATO (sol) |
| | | (69.0) | NMP (1) | (1) | (0.9) | (0.1) |
| Example 3 | 26 | MeOH | FA (2) | melamine | A-187 | Ag (sol) |
| | | (60.8) | NMP (1) | (5) | (0.9) | (0.3) |
| | | | NMAA | | | |
| | | | (4) | | | |
| Example 4 | 46.2 | MeOH | FA (2) | melamine | A-187 | Au (sol) |
| | | (42.4) | NMP (1) | (5) | (3) | (0.4) |
| Example 5 | 65 | MeOH | FA (2) | melamine | R-986 | ITO (sol) |
| | | (23.6) | NMP (1) | (7) | (1.0) | (0.2) |
| | | | | | | ATO (sol) |
| | | | | | | (0.2) |
| Comparative | 46.2 | EtOH | FA (2) | — | — | ITO (sol) |
| Example 10 | | (48.8) | NMP (1) | | | (2) |
| Comparative | 46.2 | EtOH | FA (2) | — | PET(aq) (2) | ATO (sol) |
| Example 11 | | (43.9) | NMP (1) | | TEOS (0.9) | (4) |
| Comparative | 46.2 | EtOH | FA (2) | — | PET(aq) (2) | Ag (sol) |
| Example 12 | | (37.9) | NMP (1) | | A-187 (0.9) | (10) |

PEDT: polyethylenedioxythiophene (Bayer), solid content: 1.0~1.5%
MeOH: methanol (Aldrich)
FA: formamide (Aldrich)
PET(aq): aqueous polyethyleneterephthalate solution (SKC), solid content: 20%
NMP: N-methylpyrrolidone (Aldrich)
A-187: γ-glycidyloxypropyltrimethoxy silane (Degussa)
R-986: aqueous polyurethane solution (DSM), solid content: 25% melamine resin: Aldrich, solid content: 90%
TEOS: tetraethoxysilane (Aldrich)
ITO (sol): powder, solid content: 30% (MIJITECH), 20 nm
ATO (sol): powder, solid content: 30% (MIJITECH), 10 nm
Ag (sol): silver, solid content: 30% (MIJITECH), 5 nm
Au (sol): gold, solid content: 30% (MIJITECH), 10 nm

TABLE 3

| | | | | | | | Dispersion |
|---|---|---|---|---|---|---|---|
| | | | | | | Binder | of |
| | | | | | | (polyester- | inorganic |
| | Aqueous | | Nonprotonic | | | based/urethane- | material |
| Ingredient | PEDT | | polar | Dispersion | melamine | based/alkoxysilane- | or |
| (g) | solution | Alcohol | solvent | stabilizer | resin | based) | compound |
| Example 6 | 26 | MeOH | DMSO | EG | melamine | PET(aq) | ITO (sol) |
| | | (61.9) | (4) | (6) | (1) | (1) | (0.1) |
| Example 7 | 50 | MeOH | DMSO | EG | melamine | R-986 | ATO (sol) |
| | | (36.7) | (4) | (6) | (1) | (2) | (0.3) |
| Example 8 | 50 | MeOH | DMSO | EG | melamine | A-187 | Ag (sol) |
| | | (37.6) | (4) | (6) | (1) | (1) | (0.4) |
| Example 9 | 60 | MeOH | DMSO | EG | melamine | A-187 | Au (sol) |
| | | (26.7) | (4) | (6) | (1) | (2) | (0.3) |
| Comparative | 50 | MeOH | DMSO | EG | — | — | |
| Example 13 | | (30) | (10) | (10) | | | |
| Comparative | 20 | MeOH | DMSO (10) | EG | — | — | Ag (sol) |
| Example 14 | | (53) | NMFA (1) | (10) | | | (6.0) |
| Comparative | 50 | MeOH | DMSO | EG | — | PET(aq) (2) | ATO (sol) |
| Example 15 | | (12) | (10) | (10) | | TEOS (6) | (10.0) |

PEDT: polyethylenedioxythiophene(Bayer), solid content: 1.0~1.5%
MeOH: methanol (Aldrich)
FA: formamide (Aldrich)
NMFA: N-methylformamide (Aldrich)
EG: ethyleneglycol (Aldrich)
PET(aq): aqueous polyethylene terephthalate solution(SKC), solid content: 20%
NMP: N-methylpyrrolidone (Aldrich)
DMSO: dimethylsulfoxide (Aldrich)
A-187: γ-glycidyloxypropyltrimethoxy silane (Degussa)
R-986: aqueous polyurethane solution (DSM), solid content: 25% melamine resin: Aldrich, solid content: 90%
TEOS: tetraethoxysilane (Aldrich)
ITO (sol): powder, solid content: 30% (MIJITECH), 20 nm
ATO (sol): power, solid content: 30% (MIJITECH), 10 nm
Ag (sol): silver, solid content: 30% (MIJITECH), 5 nm
Au (sol): gold, solid content: 30% (MIJITECH), 10 nm

### Test Example

### Formation of Polymer Membrane and Test for Physical Property

The liquid compositions obtained in Examples 1 to 9 and Comparative Examples 1 to 15 were each coated on a transparent substrate and dried in a oven of 150° C. for about 5 min to obtain a 5 μm thick polythiophene polymer membrane. The physical properties of the polythiophene polymer membranes thus obtained were analyzed as follows, and the results are shown Tables 4 to 6.

(A) Conductivity: analyzing the surface resistance with an ohmmeter (Loresta EP MCP-T360, Mitsubishi Chemical Co.).

(B) Transparancy: analyzing the transmission of UV-Visible light at 550 nm (by using CM-3500d, Minolta). The transmission of the coated substrate is expressed as a percentage value relative to the transmission of the non-coated original transparent substrate.

(C) Adhesive strength: analyzing the change of the surface resistance after taping the coated substrate 10 times using a taping tester (Nitto), and estimating the results as follows.

<Change of Surface Resistance>
50 Ω/m² or less: good
more than 50 Ω/m² but less than 100 Ω/m²: ordinary
100 Ω/m² or more: poor

(D) water tolerance: analyzing the change of the surface resistance after incubating a coated substrate sample for 10 days under a constant temperature (60) and constant humidity (relative humidity 90%) condition, and estimating the results as follows.

<Change of Surface Resistance>
50 Ω/m² or less: good
more than 50 Ω/m² but less than 100 Ω/m²: ordinary
100 Ω/m² or more: poor

(E) Liquid stability: storing a liquid composition sample for 1 week and checking for the sign of coagulation.

(F) Contact resistance (the sizes of the top and bottom films do not influence this value)
top film: polythiophene-based conductive polymer film
bottom film or glass: ITO film (deposition, SKC) or ITO glass (deposition) conventionally used for a touch panel
preparation and estimation: combining the top film and the bottom film or glass leaving a 1 mm space therebetween using a spacer, and determining the contact resistance using Fluke 187 True RMS Multimeter when the top film was pressed down by applying a pressure of 50 g thereto to let it contact the bottom film.

<Change of Resistance>
500Ω or more but less than 2000Ω: good
2000Ω or more: poor

TABLE 4

| Physical | Conductivity | Transparency | Water | Adhesive | Membrane | Liquid | Contact |
|---|---|---|---|---|---|---|---|
| property | (Ω/m²) | (%) | tolerance | strength | uniformity | stability | resistance |
| Comparative | 300 | 96 | good | good | good | good | poor |
| Example 1 | | | | | | | |
| Comparative | 400 | 96 | good | good | good | good | poor |
| Example 2 | | | | | | | |
| Comparative | 440 | 95 | good | good | good | good | poor |
| Example 3 | | | | | | | |
| Comparative | 350 | 96 | poor | good | good | good | poor |
| Example 4 | | | | | | | |
| Comparative | 480 | 95 | poor | good | good | good | poor |
| Example 5 | | | | | | | |
| Comparative | 650 | 95 | poor | poor | good | good | poor |
| Example 6 | | | | | | | |
| Comparative | 850 | 96 | poor | good | good | good | poor |
| Example 7 | | | | | | | |
| Comparative | 900 | 96 | poor | poor | good | good | poor |
| Example 8 | | | | | | | |
| Comparative | 900 | 96 | poor | good | good | good | poor |
| Example 9 | | | | | | | |

As shown in Table 4, the polymer membranes of Comparative Examples 1 to 3 comprising melamine resin exhibited good water tolerance as compared to the polymer membranes of Comparative Examples 4 to 9 which do not comprise melamine resin. However, the polymer membranes of Comparative Examples 1 to 9 all exhibited high contact resistance.

TABLE 5

| Physical | Conductivity | Transparency | Water | Adhesive | Membrane | Liquid | Contact |
|---|---|---|---|---|---|---|---|
| property | (Ω/m²) | (%) | tolerance | strength | uniformity | stability | resistance |
| Example 1 | 710 | 98 | good | good | good | good | good |
| Example 2 | 770 | 97 | good | good | good | good | good |
| Example 3 | 780 | 96 | good | good | good | good | good |
| Example 4 | 370 | 96 | good | good | good | good | good |
| Example 5 | 300 | 96 | good | good | good | good | good |
| Comparative | 1100 | 93 | poor | poor | good | good | poor |
| Example 10 | | | | | | | |
| Comparative | 1800 | 91 | poor | good | good | good | poor |
| Example 11 | | | | | | | |
| Comparative | 2400 | 89 | poor | good | good | good | poor |
| Example 12 | | | | | | | |

As shown in Table 5, the polymer membranes of Examples 1 to 5 showed enhanced conductivities and transparencies as well as good performance characteristics in terms of water tolerance, adhesive strength, membrane uniformity, liquid stability and low contact resistance. This appears to have resulted from the presence of the melamine resin in these membranes, as opposed to the polymer membranes of Comparative Examples 10 to 12 which do not contain such resin.

TABLE 6

| Physical | Conductivity | Transparency | Water | Adhesive | Membrane | Liquid | Contact |
|---|---|---|---|---|---|---|---|
| property | (Ω/m²) | (%) | tolerance | strength | uniformity | stability | resistance |
| Example 7 | 900 | 98 | good | good | good | good | good |
| Example 8 | 340 | 97 | good | good | good | good | good |
| Example 9 | 300 | 95 | good | good | good | good | good |
| Example 10 | 260 | 95 | good | good | good | good | good |
| Comparative | 348 | 97 | poor | poor | good | good | poor |
| Example 13 | | | | | | | |
| Comparative | 2900 | 97 | poor | poor | good | poor | poor |
| Example 14 | | | | | | | |
| Comparative | 1400 | 95 | poor | good | good | good | poor |
| Example 15 | | | | | | | |

As shown in Table 6, the polymer membranes of Examples 7 to 10 each showed good conductivity, transparency, water tolerance, adhesive strength, membrane uniformity and liquid stability as well as low contact resistance, owing to the presence of nanoparticles of an inorganic material or compound in a suitable amount, in contrast to the poor performances of the polymer membranes of Comparative Examples 13 to 15 which lack such nanoparticles.

As described above, the liquid composition comprising a polythiophene-based conductive polymer of the present invention can form a polymer membrane exhibiting high conductivity, transparency, water tolerance and durability, and low contact resistance.

While the invention has been described with respect to the above specific embodiments, it should be recognized that various modifications and changes may be made to the invention by those skilled in the art which also fall within the scope of the invention as defined by the appended claims.

1-17. (canceled)

18. A polythiophene-based conductive polymer membrane having a conductivity of 1 KΩ/m² or less, a light transmission of 95% or more, and a contact resistance ranging from 0.5 to 2 KR which comprises:
a polythiophene-based conductive polymer, an inorganic material or compound, melamine resin, and a binder.

19. The polythiophene-based conductive polymer membrane of claim 18, wherein the polythiophene-based conductive polymer is polyethylenedioxythiophene (PEDT) doped with a polystyrene sulfonate salt (PSS).

20. The polythiophene-based conductive polymer membrane of claim 18, wherein the inorganic material or compound has a particle size ranging from 1 to 100 nm.

21. The polythiophene-based conductive polymer membrane of claim 18, wherein the inorganic material or compound is selected from the group consisting of antimony tin oxide (ATO), indium tin oxide (ITO), gold (Au), silver (Ag), copper (Cu), titanium (Ti), and aluminum (Al).

22. The polythiophene-based conductive polymer membrane of claim 18, wherein the binder is selected from the group consisting of polyester, polyurethane, alkoxysilane, and a mixture thereof.

23. The polythiophene-based conductive polymer membrane of claim 18, which is formed from a liquid composition comprising (1) an aqueous solution of a polythiophene-based conductive polymer, (2) an alcohol-based organic solvent, (3) an amide-based organic solvent or a nonprotonic polar solvent, (4) a dispersion of an inorganic material or compound, (5) melamine resin, and (6) a binder selected from the group consisting of polyester, polyurethane, alkoxysilane, and a mixture thereof.

24. The polythiophene-based conductive polymer membrane of claim 23, wherein the liquid composition comprises the components (1) to (6) in amounts ranging from 20 to 70% by weight, 10 to 75% by weight, 1 to 10% by weight, 0.05 to 5% by weight, 1 to 10% by weight, and 0.1 to 5% by weight, respectively, based on the total weight of the liquid composition.

25. The polythiophene-based conductive polymer membrane of claim 23, wherein the aqueous solution of the polythiophene-based conductive polymer has a solid content ranging from 1 to 5 wt %.

26. The polythiophene-based conductive polymer membrane of claim 23, wherein the alcohol-based organic solvent is selected from the group consisting of methanol, ethanol, propanol, isopropanol, butanol, and a mixture thereof.

27. The polythiophene-based conductive polymer membrane of claim 23, wherein the amide-based organic solvent is selected from the group consisting of formamide, N-methylformamide, N,N-dimethylformamide, acetamide, N-methylacetamide, N-dimethylacetamide, N-methylpyrrolidone (NMP), and a mixture thereof.

28. The polythiophene-based conductive polymer membrane of claim 23, wherein the nonprotonic polar solvent is selected from the group consisting of dimethyl sulfoxide, propylene carbonate, and a mixture thereof.

29. The polythiophene-based conductive polymer membrane of claim 23, wherein the liquid composition comprises the nonprotonic polar solvent together with at least one dispersion stabilizer selected from the group consisting of ethyleneglycol, glycerine, and sorbitol.

30. The polythiophene-based conductive polymer membrane of claim 29, wherein the liquid composition comprises the dispersion stabilizer in an amount ranging from 1 to 10% by weight based on the total weight of the liquid composition.

31. The polythiophene-based conductive polymer membrane of claim 23, wherein the alkoxysilane is trimethoxysilane or tetraethoxysilane.

32. The polythiophene-based conductive polymer membrane of claim 23, which is formed by a method comprising coating the liquid composition on a substrate and drying the coated substrate at a temperature ranging from 100 to 145 for 1 to 10 mins.

33. The polythiophene-based conductive polymer membrane of claim 32, wherein the substrate is selected from the group consisting of a glass plate, casting polypropylene film, polyethylene terephthalate film, polycarbonate film, and acryl panel.
